(19) United States
(12) Patent Application Publication
(10) Pub. No.: US 2026/0080848 A1
(43) Pub. Date: Mar. 19, 2026

(54) BRACING FOR STRING MUSICAL INSTRUMENTS

(71) Applicant: George Gruhn, Hermitage, TN (US)

(72) Inventor: George Gruhn, Hermitage, TN (US)

(21) Appl. No.: 18/887,370

(22) Filed: Sep. 17, 2024

(51) Int. Cl. G10D 3/04

(52) U.S. Cl. CPC G10D 3/04

(57) ABSTRACT

A string music instrument comprising a soundboard, back and sides defining an inner area. The instrument having an upper bout, a waist and a lower bout. An offset, teardrop-shaped soundhole is disposed in the upper bout region and a bridge plate is disposed in the lower bout region. A soundboard bracing system including an upper transverse brace disposed at the waist region, a lower transverse brace disposed in the lower bout. A first upper brace and a second upper brace disposed between the upper transverse brace and lower transverse brace and flanking a bridge plate. Tone bars flank the bridge plate and the upper braces. The back has a back bracing having a center strip and a plurality of transverse back braces that are evenly spaced and a back panel to access the inner area.

### PRIORITY CLAIM

This application is based upon and claims the benefit of priority from U.S. Prov. Appln. Ser. No. 63/538,960, filed on Sep. 18, 2024, the entire contents of which are incorporated herein by reference.

### FIELD OF THE INVENTION

The present invention relates to string musical instruments. Specifically, the present invention relates to soundboard bracing systems.

### BACKGROUND OF THE INVENTION

String musical instruments bracing refers to the system of wooden struts which internally support and reinforce the soundboard and back of instruments such as acoustic guitars. Soundboard or top bracing strike a balance that strengthens the guitar top and enables vibration of the soundboard versus forces exerted by the strings from the bridge to the headstock. The luthier faces the challenge of bracing the instrument to withstand the stress applied by the strings with minimal distortion, while permitting the top to respond as fully as possible to the tones generated by the strings. Brace design contributes significantly to the type of sound a guitar will produce. The back of the instrument is braced to help distribute the force exerted by the neck on the body, and to maintain the tonal responsiveness and structural integrity of the sound box. Bracing comprises pieces of wood which are glued to the inner surface of the sound board and gives the instrument its voice. There are many types of braces, for example, ladder, fan, X, A frame braces, and tone bars.

### SUMMARY OF THE INVENTION

The present string musical instrument design achieves a and readily recognizable physical appearance, bracing and distinctive sound.

While various components of the guitar of the present invention are conventional, the way they have been combined herein results in a guitar that is dramatically different structurally from any other acoustic guitar on the market today and offers advantages in ease of manufacture, as well as sound. The only historical instrument that arguably resembles it is the TACOMA guitar with an offset sound hole which was also designed by the inventor herein, George Gruhn. The present design takes the TACOMA design to a further evolutionary step. It is more effective in transmitting sound and is a better sounding instrument than the TACOMA.

The prototype TACOMA and the new Gruhn VERSITAR™ are braced in much the same manner as an archtop guitar or a carved top F hole mandolin, but this concept had never been applied before to a flattop guitar. VERSITAR™ baritone and bass guitar models conceived with the present invention will feature an additional longitudinal center tone bar on the top.

The inventor knows of no other guitar, past or present, that has a teardrop shape sound hole similar to the one on the guitar of the present invention. The positioning of the sound hole is not unique since there are other makers doing offset sound holes in this position, but none of them are braced as is the guitar of the present invention. In the present invention, a bolt-on-neck design is presented which utilizes bolts fitting into metal fixtures and a shaped neck block which reduces stress on the upper bout of the top permitting it to vibrate more freely. The present design has the bolts threaded into metal inserts in the neck, which, when coupled with the offset sound hole and the top bracing results in an acoustic instrument unlike any other on the market today. The bolt-on-neck fastening, wherein with bolts are fastened into threaded metal inserts in the neck is unusual since most guitar makers utilizing so called bolt-on neck construction actually use wood screws rather than bolts. However, wood screws can strip the holes if the neck is removed and reinstalled a few times, whereas bolts in threaded metal fittings are very stable. The present design not only looks different; because of the neck attachment methodology, coupled with the bracing pattern and sound hole placement, the invention is structurally different and has a new sound which is notably and recognizably different from any other acoustic guitar on the market today. The guitar of the present invention is thus capable of playing musical styles which normally would not be attempted on an acoustic guitar, but would be reserved for electric guitars, and is versatile enough that it is applicable for any standard acoustic styles. The Gruhn VERSITAR™ is easily identified even by an untrained observer by sight and sound as distinctly different from instruments produced by any other manufacturer of new guitars currently available.

### BRIEF DESCRIPTION OF THE DRAWINGS

FIG. 1 is a front elevational view of the guitar body of the present invention showing a bracing system on the underside of the guitar top.

FIG. 2 is a rear elevational view of the guitar and interior of the guitar body of the present invention.

FIG. 3 is a plan view of the guitar with the bracing structure and interior of the guitar body of the present invention.

FIG. 4 is a sectional view of the guitar and interior of the guitar body of the present invention.

### DETAILED DESCRIPTION OF THE INVENTION

As discussed above, the present guitar 1000 is fundamentally different from conventional flat top or any other acoustic guitar on the market today or which has been made in the past. As exemplified by the drawings and discussion herein, the top is braced with two asymmetrical top bracing bars similar in construction to an archtop plus a bridge plate. This gives it longitudinal strength and permits the entire top to vibrate, as opposed to traditional flat top guitar design in which vibration of the top is primarily confined to the lower bout. The sound hole placement allows the sound to be projected to an audience as well as to the player. The neck is also similar to an electric guitar neck in which the fingerboard is supported by the neck for its entire length and the truss rod runs the full length of the neck. There is no neck heel to get in the player's way and a deep cutaway permits the player to reach all twenty-two frets. Unlike most flat top cutaway guitars in which the notes in the cutaway area are not nearly as loud or harmonically complex as the notes from the nut to the body joint, and in which the truss rod does not go the full length of the fingerboard, all the notes played on the guitar of the present invention sound consistent in every fret position so that the notes are not only reachable in the cutaway, but they maintain equal volume and tonal characteristics along the full length of the fingerboard. The guitar of the present invention provides substantial volume, but is well-balanced, and has a significantly enhanced tone and dynamic range.

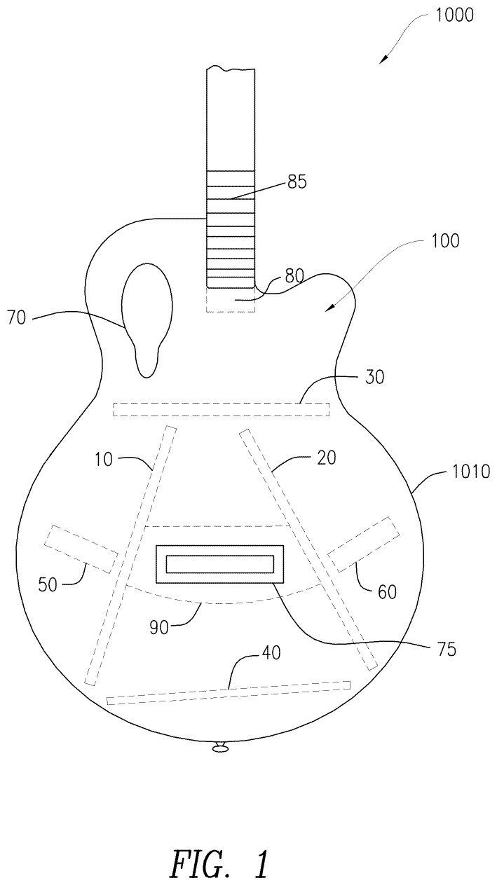

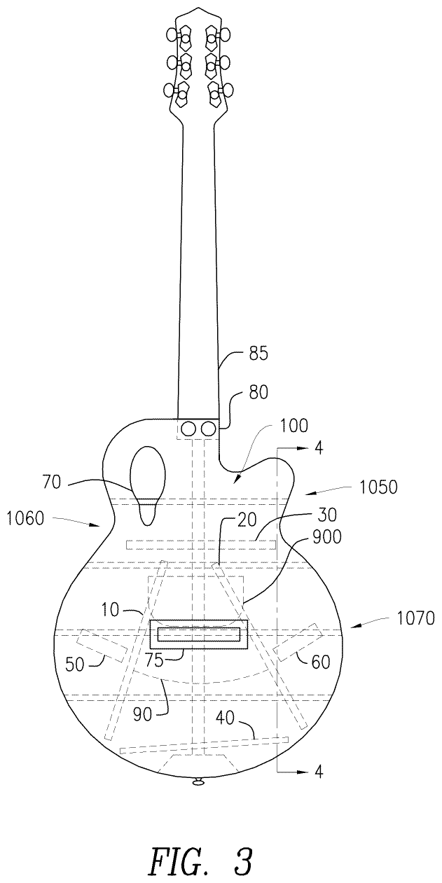

Referring now to the drawings, FIG. 1 shows an embodiment of a guitar 1000 of the present invention in front elevational view. In some embodiments, the guitar is an acoustical stringed instrument. The guitar 1000 has a body defined by a soundboard or guitar top 1010, a back 1030, and a side 1020 coupling soundboard 1010 and back 1030 to be in a spaced apart relationship defining an inner area 1040. The guitar body has defined therein an upper bout region 1050, a waist region 1060 and a lower bout region 1070. See FIG. 3. Neck 85 includes a front block 80 to which the neck 85 couples to the guitar body. At an opposite end of guitar 1000 is a rear block 800 in the lower bout 1070. Not shown but apparent to a user is strings that are anchored on a bridge and saddle 75 which is coupled to the soundboard 1010 in the lower bout 1070. The strings run from the bridge and saddle 75 to tuners or tuning machines on a guitar head on which the ends of strings are wound.

An offset sound hole 70 is defined in the upper bout 1050 to the side of the neck 85. On an underside of the guitar top 1010 is a bracing system 100 showing a pair of upper braces 10, 20 that are asymmetrical and disposed between an upper transverse brace 30 and a lower transverse brace 40. A pair of tone bars 50 flank the upper braces 10, 20, which in turn flank a bridge plate 90 that is disposed under the bridge and saddle 75.

The first upper brace 10 and the second upper brace 20 each have a first end adjacent or under the upper transverse brace 30 and a second end adjacent or above the lower transverse brace 40. The first upper brace first end is disposed a first distance from said second upper brace first end and said first upper brace second end is disposed a second distance from said second upper brace second end, wherein the first distance is shorter than the second distance. The pair of upper braces 10, 20 have a length. Mid-way of the length of each upper brace 10, 20 is disposed the bridge plate 90 on one side and on the other side of the upper braces are the tone bars 60. The upper transverse brace 30 is disposed at the waist region 1060.

The upper transverse brace 30, lower transverse brace 40, and the pair of tone bars 50, 60 improve stability of the guitar 1000. The top bracing 10, 20 are primary braces that provide the support and function to give the guitar 1000 its distinctive tonal character. The upper transverse brace 30 supports the guitar top and takes the load off the neck due to string tension, preventing the guitar top from caving in behind the neck 85. The lower transverse brace 40 supports the area behind the bridge and saddle 75 and bridge plate 90, reducing bridge lift. The tone bars 50, 60 add stiffness to the top. This increase in rigidity increases higher frequency response and an overall more tension balanced top. In a preferred embodiment, the bracing system 100 will be positioned as shown in relation to the size of the guitar top and interaction with the bridge plate 90. The bracing system adds stiffness to the top 1010 and work in unison to reduce torquing effects from string tension.

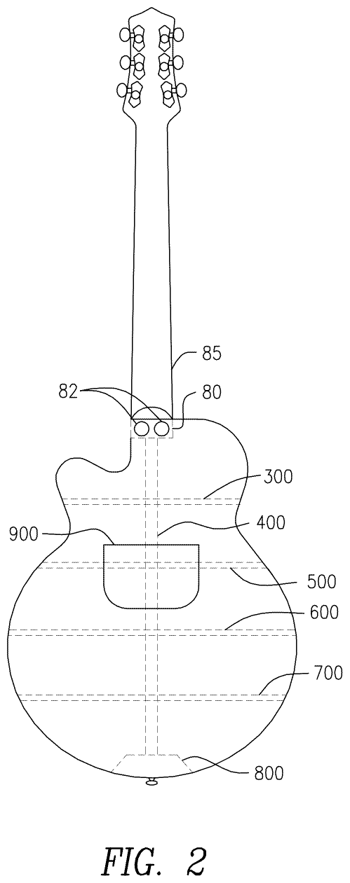

FIG. 2 shows a rear elevational view the guitar 1000 of the present invention with back 1030 bracings 300, 500, 600, 700, a center strip 400, a front block 80, bolt 82, neck 85, and a rear block 800 and an access panel 900 which facilitates ease of access to the interior or inner area 1040 for electric pickup installation and any future maintenance. The back bracings 300, 500, 600, 700 are placed equidistant from the neighboring bracing. The front block 80 serves to set the neck 85 using bolts 82.

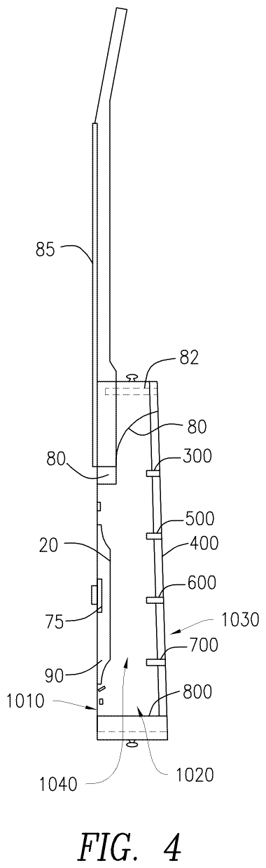

FIG. 3 shows guitar 1000 from the front showing the soundboard 1010 and the back 1030 with the bracing system 100 and the bracings 300, 500, 600, 700, a center strip 400 on the back 1030. FIG. 4 shows a cut away sectional view of the guitar 1000 showing the bracing system 100 on the guitar top 1010 and the back bracings 300, 500, 600, 700, showing the front block 80, bolt 82, neck 85 and rear block 800. As stated above the braces add stiffness to the top and work in unison to reduce the torquing effect from string tension.

While the foregoing is directed to embodiments of the present invention, other and further embodiments of the invention may be devised without departing from the basic scope thereof, and the scope thereof is determined by the claims that follow.

1. A string music instrument comprising:
a soundboard having an upper bout region, a waist region and a lower bout region;
a soundhole, said soundhole being disposed in the upper bout region;
a bridge plate, said bridge plate disposed in the lower bout region;
a soundboard bracing system having
an upper transverse brace, said upper transverse brace disposed at the waist region;
a lower transverse brace, said lower transverse brace disposed in the lower bout region;
a first upper brace having a first end, a second end and a length, said first upper brace first end disposed adjacent the upper transverse brace and said first upper brace second end being disposed adjacent the lower transverse brace;
a second upper brace having a first end, a second end and a length, said second upper brace first end disposed adjacent the upper transverse brace and said second upper brace second end being disposed adjacent the lower transverse brace; and
tone bars.

2. The string music instrument of claim 1, wherein the bridge plate is flanked by the first upper brace and the second upper brace.

3. The string music instrument of claim 1, wherein the bridge plate is disposed mid-length of each the first upper brace and the second upper brace.

4. The string music instrument of claim 1, wherein the bridge plate is flanked by the tone bars.

5. The string music instrument of claim 1, wherein the first upper brace and the second upper brace are flanked by the tone bars.

6. The string music instrument of claim 1, wherein said first upper brace first end and said second upper brace first end are disposed below the upper transverse brace.

7. The string music instrument of claim 1, further comprising a back having an upper bout region, a waist region and a lower bout region, said back connected to the soundboard with sides, said soundboard, said back and said sides defining an inner area.

8. The string music instrument of claim 7, wherein said back has a back bracing and a center strip.

9. The string music instrument of claim 8, wherein the back bracing comprises a plurality of transverse back braces, said back braces are evenly spaced and disposed on each the upper bout region, the waist region and the lower bout region of the back.

10. The string music instrument of claim 8, further comprising an access panel disposed on the back, said access panel being selectively openable exposing the inner area.

11. The string music instrument of claim 1, wherein said soundhole is teardrop shaped.

12. The string music instrument of claim 8, further comprising a metal, bolt-on-neck fastening, wherein bolts are fastened into threaded metal inserts in the neck fastening.

13. The soundboard of claim 1, wherein said first upper brace first end is disposed a first distance from said second upper brace first end and said first upper brace second end is disposed a second distance from said second upper brace second end, wherein the first distance is shorter than the second distance.

14. A string music instrument soundboard having an upper bout region, a waist region and a lower bout region comprising:
a soundboard bracing system having
a soundhole, said soundhole being disposed in the upper bout;
a bridge plate, said bridge plate disposed in the lower bout;
an upper transverse brace, said upper transverse brace disposed at the waist region;
a lower transverse brace, said lower transverse brace disposed in the lower bout;
a first upper brace having a first end, a second end and a length, said first upper brace first end disposed adjacent the upper transverse brace and said first upper brace second end being disposed adjacent the lower transverse brace;
a second upper brace having a first end, a second end and a length, said second upper brace first end disposed adjacent the upper transverse brace and said second upper brace second end being disposed adjacent the lower transverse brace, wherein said first upper brace first end is disposed a first distance from said second upper brace first end and said first upper brace second end is disposed a second distance from said second upper brace second end, wherein the first distance is shorter than the second distance; and
tone bars.

15. The soundboard of claim 14, wherein the bridge plate is flanked by the first upper brace and the second upper brace.

16. The soundboard of claim 14, wherein the bridge plate is disposed mid-length of each the first upper brace and the second upper brace.

17. The soundboard of claim 14, wherein the first upper brace and the second upper brace are flanked by the tone bars.

18. The soundboard of claim 14, wherein said first upper brace first end and said second upper brace first end are disposed below the upper transverse brace.
